(19) United States
(12) Patent Application Publication
(10) Pub. No.: US 2005/0117533 A1
(43) Pub. Date: Jun. 2, 2005

(54) Wireless communication method and apparatus for implementing call admission control based on common measurements

(75) Inventor: Christopher Cave, Candiac (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/982,845

(22) Filed: Nov. 5, 2004

Related U.S. Application Data
(60) Provisional application No. 60/518,380, filed on Nov. 7, 2003.

(51) Int. Cl. H04B 7/212

(52) U.S. Cl. 370/321

(57) ABSTRACT

A method and apparatus for admission control based on Node-B measurements in a wireless communication system is disclosed. Once a call request is received, a code is selected among available codes for potential allocation. A target cell load and a neighbor cell load for each of available timeslots is calculated assuming additional allocation of the selected code to each of the timeslots using Node-B measurements. A weighted system load for the timeslot is calculated. A timeslot having a smallest weighted system load is selected for allocation of the code.

### CROSS REFERENCE TO RELATED APPLICATION

This application claims the benefit of U.S. provisional application No. 60/518,380 filed Nov. 7, 2003 which is incorporated by reference as if fully set forth.

### FIELD OF INVENTION

The present invention is related to a wireless communication system. More particularly, the present invention is a method and apparatus for admission control based on common measurements performed in a wireless communication system.

### BACKGROUND

In wireless communication systems, a wireless transmit/receive unit (WTRU) communicates with a radio access network (RAN) via one or more radio channels which are established upon request from the WTRU or a core network. Upon receiving a call request for radio resources, a call admission control (CAC) process in a radio network controller (RNC) is invoked to process the request. The CAC process determines whether or not a call should be admitted to the system. If the call is admitted, the CAC process determines the most efficient allocation of radio resources.

In order to make such decisions, the CAC process must be aware of the state of the system at the time when the request is received. Power and interference measurements are typically used to characterize the current state of the system. Measurements may be made by a Node-B or a WTRU. Measurements made by a Node-B may include uplink (UL) interference, downlink (DL) carrier power level, and/or DL code transmission power. Measurements made by a WTRU may include UL total transmission power level, UL code transmission power level, DL interference, and/or path loss.

In many cases, measurements made by a WTRU are not available at the RNC. Thus, the CAC process must rely only on measurements made by a Node-B for admission control and resource allocation. Accordingly, a method and apparatus for implementing call admission control and resource allocation based only on measurements made by a Node-B is desired.

### SUMMARY

A method and apparatus for implementing call admission control based on Node-B measurements in a wireless communication system is disclosed. The apparatus may be an integrated circuit (IC), Node-B or a wireless communication system. A coverage area of the wireless communication system is divided into a plurality of cells and each cell is served by a Node-B. Once a call request is received, a code is selected among available codes for potential allocation. A target cell load and a neighbor cell load for each of the available timeslots is calculated assuming additional allocation of the selected code to each of the timeslots using Node-B measurements. A weighted system load for the timeslot is calculated. A timeslot having a smallest weighted system load is selected for allocation of the code.

### BRIEF DESCRIPTION OF THE DRAWINGS

A more detailed understanding of the invention may be had from the following description of a preferred example, given by way of example and to be understood in conjunction with the accompanying drawing wherein:

FIG. 1 is a flow diagram of a process including method steps for implementing CAC based on UL measurements in accordance with the present invention;

FIG. 2 is a flow diagram of a process including method steps for implementing CAC based on DL measurements in accordance with the present invention;

FIG. 3 is a diagram of a wireless communication system model in accordance with the present invention; and

FIG. 4 is a block diagram of an apparatus used to implement CAC in the system of FIG. 3.

### DETAILED DESCRIPTION OF THE PREFERRED EMBODIMENTS

The present invention will be explained, for simplicity, in the context of a universal mobile telephone system (UMTS). However, it should be noted that the present invention may be implemented in any type of wireless communication system based on hybrid time division multiple access (TDMA)-code division multiple access (CDMA).

The features of the present invention may be incorporated into an integrated circuit (IC) or be configured in a circuit comprising a multitude of interconnecting components.

Hereafter, the terminology “WTRU” includes but is not limited to a user equipment, a mobile station, a fixed or mobile subscriber unit, a pager, or any other type of device capable of operating in a wireless environment. When referred to hereafter, the terminology “Node-B” includes but is not limited to a base station, a site controller, an access point or any other type of interfacing device in a wireless environment.

A CAC process of the present invention utilizes common measurements (i.e. measurements not dedicated to any specific radio link) made by a Node-B. The measurements may be either UL measurements or DL measurements. Optionally, the CAC process may utilize path loss information reported by a WTRU. When path loss information is available, the CAC process uses it. When path loss information is not available, a path loss parameter is used as an input, which will be explained hereinafter.

The UL measurement-based CAC process of the present invention uses a load metric of the target and neighboring cells in order to make a call admission decision and assign physical radio resources to the requested call.

With respect to load computation for target cell(s), a predicted interference level, ISCP_{PRED}(i,t), resulting from the addition of one or more codes in timeslot t of cell i is preferably predicted using a noise rise function of the target cell, R_{T}.
ISCP_{PRED}(i,t)=ISCP(i,t)×R_{T}(ISCP(i,t),A(i),SIR); (Equation 1)
where ISCP(i,t) is a UL timeslot interference signal code power (ISCP) measurement measured by the Node-B, A(i) is a path loss to the target cell, and SIR is a sum of the chip-level SIR targets of the added codes. The noise rise function, R_{T} is preferably given by:

$${R}_{T} = \frac{1}{1 - ( \frac{{I}_{0}}{θ} - 1 ) \frac{L SIR}{q + \frac{1}{{G}_{c}}}} ; \qquad ( Equation 2 )$$

where θ is a thermal noise level, L is a path loss, q is a load of the cell, and G_{C} is a link gain.

The CAC process of the present invention may operate using only the measurements made by the Node-B, and does not have to use a path loss measurement reported from a WTRU. However, if a path loss measurement reported by the WTRU is available, such as during a handover, the path loss measurement is used as an input to the noise rise function, R_{T}. Otherwise, a path loss value parameter is used instead of a path loss measurement. The path loss value parameter should be determined from the distribution of path losses measured throughout the cell through operation, administration and maintenance (OA&M). For example, the 50th percentile path loss for a given cell deployment may be used.

The estimated load in a particular timeslot t of cell i is preferably computed as follows:

$$L ( i , t ) = 1 - \frac{{N}_{O}}{{ISCP}_{PRED} ( i , t )} ; \qquad ( Equation 3 )$$

where N_{O} represents the receiver noise level. The estimated load, L(i,t), is used to evaluate the admission of the requested resource units in the timeslot.

With respect to load computation for neighboring cells, the load of timeslot t in neighboring cell j is computed as follows:

$$L ( j , t ) = 1 - \frac{{N}_{O}}{ISCP ( j , t )} ; \qquad ( Equation 4 )$$

for all j ≠i. The current ISCP measurement of Node B j is available to the target cell and used as an input for the load computation. The resulting load, L(j,t), is used to evaluate the admission of the requested resource units in the timeslot.

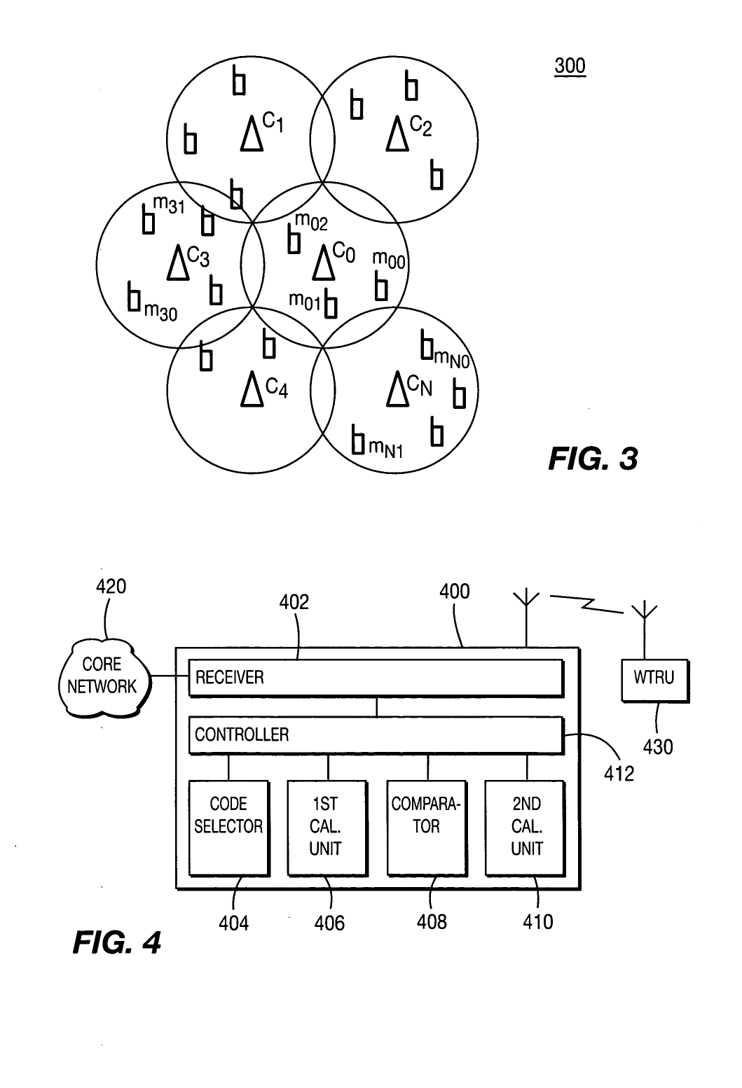

In an alternate embodiment, the load of timeslot t in neighboring cell j may be computed using the noise rise in neighboring cell j. In this embodiment, a noise rise function of neighboring cells may be estimated using a noise rise function of the target cell to estimate the increase of interference in neighboring cells assuming a code(s) is assigned thereto as follows:
R_{N}=R_{T}(1+G_{C}×A(i)×SIR); (Equation 5)
where R_{T} is given in Equation 2, G_{C} is a calibration parameter, A(i) represents the path loss to the target cell and SIR is the sum of the chip-level SIR targets of the added codes. The derivation of a noise rise function of neighboring cells from a noise rise function of a target cell is explained in more detail with reference to FIG. 3. In this embodiment, Equation 4 is replaced with:

$$L ( j , t ) = 1 - \frac{{N}_{O}}{ISCP ( j , t ) \times {R}_{N}} . \qquad ( Equation 6 )$$

The allocation of one or more codes in timeslot t of cell i is accepted if and only if the following conditions are satisfied:
L(i,t)<LT_{MAX}; and (Equation 7)
L(j,t)<LN_{MAX}; (Equation 8)
for all neighboring cells j under consideration. L(i,t) and L(j,t) are computed as described in Equation 3 and Equation 4 (or alternatively, Equation 6), respectively. LT_{MAX} and LN_{MAX} represent the load thresholds for the target cell and neighboring cells.

It is noted that the allocation of a code(s) to a timeslot must satisfy WTRU capability requirements; otherwise, the allocation of the set of codes is rejected. For example, the UMTS standard defines a plurality of different classes of WTRUs. Each class is defined by a different set of capabilities. One of the capability requirements of a WTRU is the number of codes that the WTRU supports in a single timeslot, as well as the number of different timeslots the WTRU can simultaneously support. The lower class WTRUs support less codes per timeslot, whereas the higher class WTRUs support more codes per timeslot. A Node-B is aware of the WTRU class and hence, of the WTRU's capabilities in terms of the number of supported codes per timeslot and the number of supported timeslots. Therefore, before actually allocating codes to a particular WTRU in a given timeslot, it should be confirmed that the WTRU can handle the number of allocated codes in the timeslot.

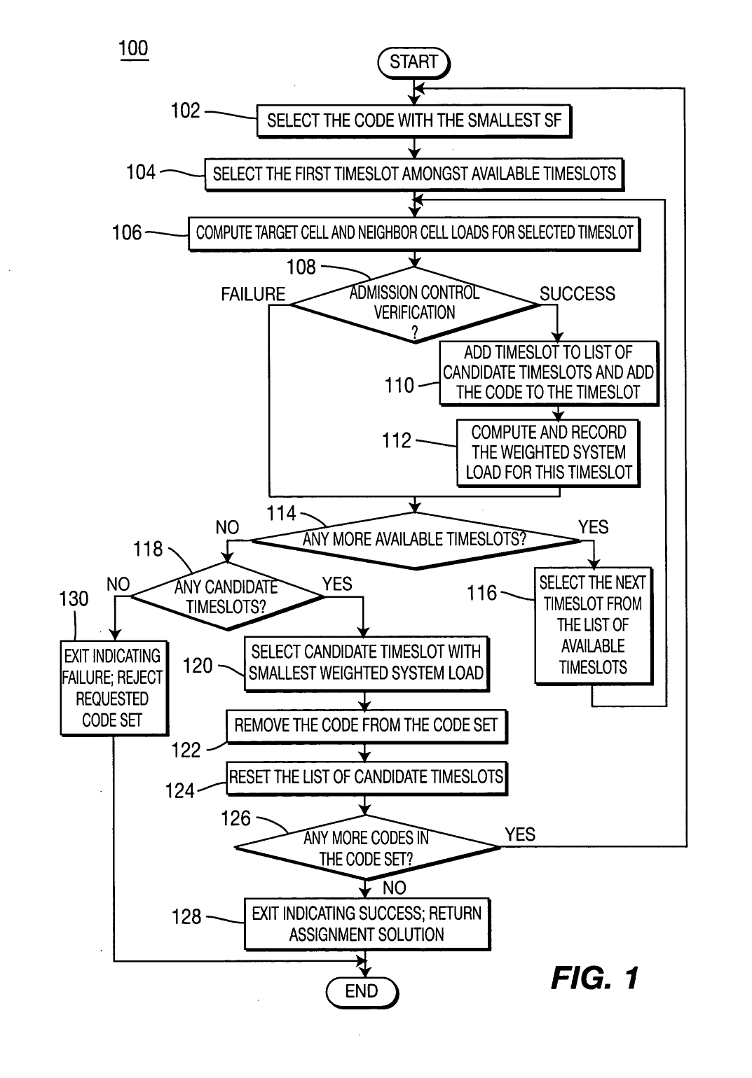

FIG. 1 is a flow diagram of a process 100 including method steps for implementing CAC based on UL measurements in accordance with the present invention. When a wireless communication system receives a call request for a WTRU, a code is selected from a list of available code sets (step 102). The selected code is preferably the code with the smallest spreading factor (SF) in the code set. A first timeslot is also selected for potential allocation amongst available timeslots (step 104). The set of available timeslots consists of all timeslots that are available for the requested service type, (e.g., real time (RT) or non-real time (NRT)), and direction, (i.e., UL or DL). The set of available timeslots is set through OA&M.

The process computes a target cell load and a neighboring cell load for the selected timeslot assuming the selected code is added to the selected timeslot in accordance with Equation 3 and Equation 4 (or alternatively, Equation 6) (step 106). In Equation 3, the load computation considers all codes from the code set that have already been allocated to the selected timeslot.

The process 100 then verifies CAC by determining whether the estimated target cell load and a neighboring cell load are below predetermined thresholds, respectively (step 108). If either the estimated target cell load or the estimated neighboring cell load is not below the thresholds, the code is not added to the timeslot for allocation, and the process proceeds to step 114. If both the estimated target cell load and the estimated neighboring cell load are below the thresholds, the selected code is added to the timeslot, at which point the timeslot becomes a candidate timeslot for potential allocation of the selected code and is added to a list of candidate timeslots (step 110). Once the code is added to the timeslot, a weighted system load is computed for the timeslot at step 112 as follows:

$${L}_{SYSTEM} ( t ) = \frac{L ( i , t ) + {\sum }_{j = 1}^{{𝔍}_{1}} {α}_{1} L ( j , t ) + {\sum }_{j = 1}^{{𝔍}_{2}} {α}_{2} L ( j , t )}{1 + η N ( t )} ; \qquad ( Equation 9 )$$

where ℑ₁ and ℑ₂ define respectively the set of tier one and tier two neighboring cells to be included in the overall system load. α₁ and α₂ represent weighting factors to be applied to tier one and tier two cell loads. The denominator, 1+ηN(t), is a fragmentation adjustment factor, where η corresponds to the fragmentation adjustment parameter and N(t) corresponds to the number of codes already assigned to the timeslot. Once the weighted system load has been computed, the process 100 proceeds to step 114.

If it is determined that there are more available timeslots at step 114, the next timeslot is selected from the list of available timeslots (step 116), and the process 100 returns to step 106. If there are no available timeslots for computing a weighted system load, the process 100 determines whether there are any candidate timeslots (step 118). If there are no candidate timeslots, the process 100 indicates a failure of allocation of resources and rejects the requested code set (step 130). If there are candidate timeslots, a timeslot having a smallest weighted system load, L_{SYSTEM}(t) is selected thereby resulting in allocation of the selected code in the selected candidate timeslot (step 120). The allocated code is removed from a list of available code sets (step 122), and a list of candidate timeslots is reset (step 124). If there are more available codes in a code set, as determined in step 126, the process 100 returns to step 102. If not, the process 100 proceeds to step 128 where the process 100 indicates a successful allocation of resources and returns a resource assignment solution for the call request (step 128).

The DL measurement-based CAC process of the present invention uses a transmit carrier power of the target cell and neighboring cells in order to make an admission decision and assign physical resources to a requested call. The DL ISCP is predicted using carrier powers of neighboring cells. The DL ISCP in timeslot t of a WTRU located in cell i, I_{DL}(i,t), can be expressed according to:

$${I}_{DL} ( i , t ) = {N}_{O} + {\sum }_{j ∈ {𝔍}_{1}} \frac{{P}_{T} ( j , t )}{A ( j )} + {\sum }_{j ∈ {𝔍}_{2}} \frac{{P}_{T} ( j , t )}{A ( j )} ; \qquad ( Equation 10 )$$

where N_{O} represents a receiver noise level, A(j) represents a path loss between a WTRU and a cell j, and P_{T}(j,t) represents a total DL transmit power of cell j in timeslot t. All quantities are expressed using a linear scale. ℑ₁ and ℑ₂ define respectively the set of tier one and tier two neighboring cells to be included in the interference prediction. The information about carrier transmission powers of neighboring cells is available to a target cell. However, the information about a path loss from the WTRU to neighboring cells is not available to the target cell. Therefore, the DL ISCP is estimated as follows:

$$\begin{matrix}E [ {I}_{DL} ( i , t ) ] = {N}_{O} + {\sum }_{j ∈ {𝔍}_{1}} E [ {X}_{1} ] {P}_{T} ( j , t ) + & ( Equation 11 ) \\ {\sum }_{j ∈ {𝔍}_{2}} E [ {X}_{2} ] {P}_{T} ( j , t ) & \\ = {N}_{O} + {μ}_{1} {\sum }_{j ∈ {𝔍}_{1}} {P}_{T} ( j , t ) + {μ}_{2} {\sum }_{j ∈ {𝔍}_{2}} {P}_{T} ( j , t ) ; & \end{matrix}$$

where X₁ is a random variable corresponding to a link gain (i.e. inverse of a path loss) between the WTRU and a neighboring tier 1 cell Node B, X₂ is a random variable corresponding to a link gain between the WTRU and a neighboring tier 2 cell Node B, and μᵢ and μ₂ represent the mean link gains between the WTRU located in the target cell and the Node Bs serving tier 1 and tier 2 cells. The mean link gains are cell deployment-specific parameters which are set through OA&M.

Once the expected interference level is calculated, the interference resulting from the addition of one or multiple codes in timeslot t of cell i is predicted as follows using the noise rise function of the target cell described in Equation 2:
I_{DL}^{PRED}(i,t)=E[I_{DL}(i,t)]×R_{T}(E[I_{DL}(i,t)],A(i),SIR); (Equation 12)
where A(i) represents a path loss to the target cell and SIR represents a sum of the chip-level SIR targets of the added codes.

If the WTRU path loss measurement is available to the target cell, such as during a handover, the WTRU path loss measurement is used as an input for calculating the target cell noise rise function. Otherwise, a path loss value parameter is used, which is set through OA&M. The path loss value parameter should be determined from the distribution of path losses measured throughout the target cell.

The carrier power resulting from the addition of one or multiple codes in timeslot t of cell i is predicted as follows:
P_{T}PRED(i,t)=P_{T}(i,t)×R_{T}(E[I_{DL}(i,t)],A(i),SIR)+I_{DL}^{PRED}(i,t)×A(i)×SIR; (Equation 13)
where A(i) and SIR represent respectively the path loss to the target cell and the sum of the chip-level SIR targets of the added codes. The increase of interference resulting from the addition of the code is applied to existing codes as well. This is achieved by multiplying the current transmission power by the noise rise. The resulting predicted carrier transmission power, P_{T}^{PRED}(i,t), is expressed in Watts.

In an alternate embodiment, the carrier power in neighboring cells can be predicted according to:
P_{T}^{PRED}(j,t)=P_{T}(j,t)×R_{N}; (Equation 14)
where R_{N} is calculated according to Equation 5.

The allocation of a set of codes in timeslot t of cell i is accepted if and only if the following conditions are satisfied:
(10 log₁₀(P_{T}^{PRED}(i,t))−M_{T})<P_{T}^{MAX}; and (Equation 15)
(10 log₁₀ (P_{T}(j,t))−M_{N})<P_{T}^{MAX}; (Equation 16)
for all neighboring cells j under consideration. P_{T}^{PRED} (i,t) is computed as described in Equation 13. M_{T} and M_{N} represent respectively CAC power margins for the target and neighbor cells. P_{T}^{MAX} corresponds to the maximum Node-B timeslot carrier power, expressed in dB, which is set through OA&M.

If the carrier power is predicted in neighboring cells according to Equation 14, then Equation 16 is replaced by:
(10 log₁₀(P_{T}^{PRED}(j,t))−M_{N})<P_{T}^{MAX}. (Equation 17)

Moreover, the allocation of the set of codes must satisfy WTRU capability requirements; otherwise, the allocation of the set of codes is rejected.

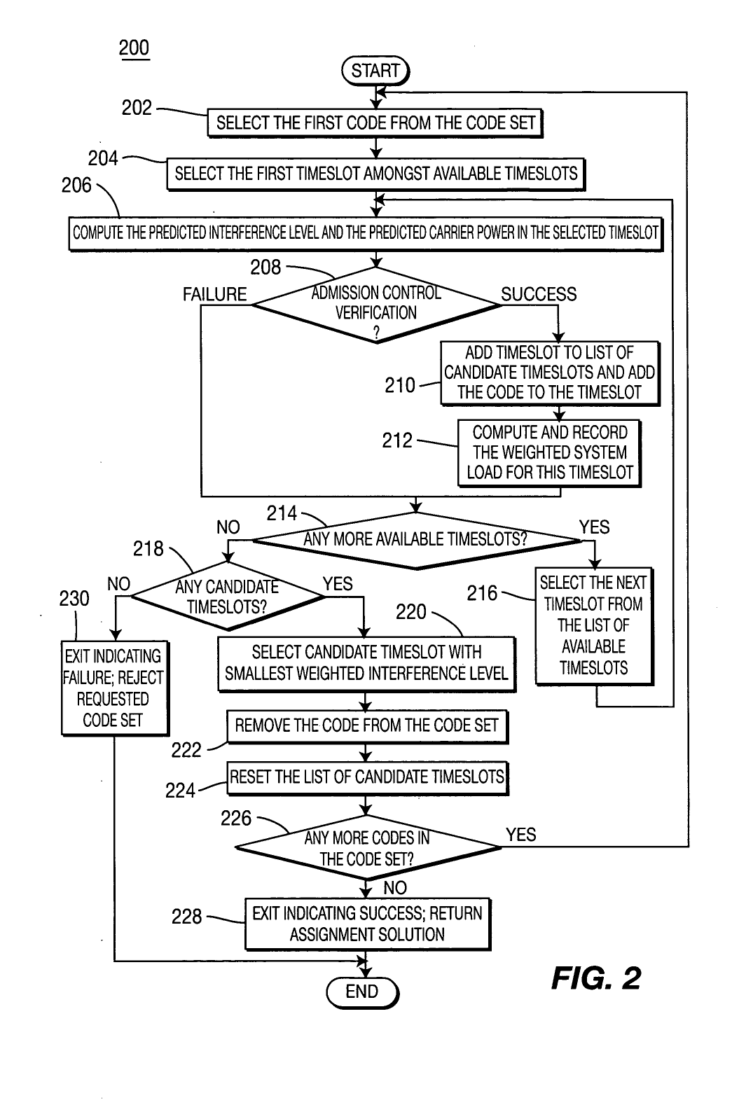

FIG. 2 is a flow diagram of a process 200 including method steps for implementing CAC based on DL measurements in accordance with the present invention. When a wireless communication system receives a call request for a WTRU, a code is selected from a list of available code sets (step 202). Under the current third generation partnership project (3GPP), only SF 16 codes are used for DL. However, other SF codes may be used for DL. Thus, a code may be selected, starting from a code having a smallest spreading factor (SF) in the code set. A first timeslot is also selected for potential allocation amongst available timeslots (step 204). The set of available timeslots consists of all timeslots that are available for the requested service type, (e.g., RT or NRT), and direction, (i.e., UL or DL). The set of available timeslots is set through OA&M.

The process 200 computes a predicted interference level and carrier transmission power of a target cell and a predicted interference level and carrier transmission power of neighboring cells for the selected timeslot assuming the selected code is added to the selected timeslot in accordance with Equation 12 and Equation 13 (or alternatively, Equation 14) (step 206). In Equations 12 and 13, the computation considers all codes from the code set that have already been allocated to the selected timeslot.

The process 200 then verifies admission control by determining whether the estimated target cell carrier transmission power and a neighboring cell carrier transmission power are below predetermined thresholds, respectively (step 208). If both the estimated target cell carrier transmission power and the estimated neighboring cell carrier transmission power are below the thresholds, the selected code is added to the timeslot, at which point the timeslot becomes a candidate timeslot for potential allocation of the selected code and is added to a list of candidate timeslots (step 210). If either the estimated target cell carrier transmission power or the estimated neighboring cell carrier transmission power is not below the thresholds, the code is not added to the timeslot for allocation, and the process proceeds to step 214.

Once the code is added to the timeslot, a weighted interference level is computed for the timeslot at step 212 as follows:

$${I}_{DL}^{W} ( i , t ) = \frac{{I}_{DL}^{PRED} ( i , t )}{1 + γ N ( t )} . \qquad ( Equation 18 )$$

The denominator, 1+γN(t), is a fragmentation adjustment factor, where λ corresponds to the fragmentation adjustment parameter and N(t) corresponds to the number of codes already assigned to this timeslot.

If it is determined that there are more available timeslots at step 214, the next timeslot is selected from the list of available timeslots (step 216), and steps 202-214 are repeated. If there are no available timeslots for computing a weighted interference level, the process 200 determines whether there are any candidate timeslots (step 218). If there are no candidate timeslots, the process 200 indicates a failure of allocation of resources and rejects the requested code set (step 230). If there are candidate timeslots, a timeslot having a smallest weighted interference level, I_{DL}^{W}(i,t) is selected thereby resulting in allocation of the selected code in the selected candidate timeslot (step 220). The allocated code is removed from a list of available code sets (step 222), and a list of candidate timeslots is reset (step 224). If there are more codes in a code set, the process returns to step 202 for evaluation of each code, and if not, the process proceeds to step 228 (step 226). In step 228, the process 200 indicates a successful allocation of resources and returns a resource assignment solution for the call request.

The derivation of the noise rise function for neighboring cells from a noise rise function of the target cell is explained in more detail with reference to FIG. 3. FIG. 3 is a diagram of a wireless communication system model 300 in accordance with the present invention. There are a total of N+1 cells C₀-C_{N} and the number of WTRUs mᵢₗ-m_{iN} in cell C₁ is Nᵢ+1. The WTRUs mᵢₗ-m_{iN} served by cell Cᵢ are denoted by {mᵢⱼ}. The analysis presented hereinafter applies for both UL and DL.

Iᵢⱼ is an interference level seen by WTRU mᵢⱼ (for DL) or by a Node-B serving WTRU mᵢⱼ (for UL). The required transmission power for serving a WTRU mᵢⱼ is equal to:
Pᵢⱼ=IᵢⱼSIRᵢⱼLᵢⱼ (Equation 19)
where Lᵢⱼ is a path loss between a cell Cᵢ and a WTRU mᵢⱼ, and SIRᵢⱼ is a required signal-to-interference ratio to adequately serve the WTRU mᵢⱼ. This power is transmitted either by the WTRU mᵢⱼ (in case of UL) or by its serving Node-B (in case of DL).

Equation 19 can be re-written:
Pᵢⱼ=Iᵢⱼqᵢⱼ (Equation 20)
where qᵢⱼ≡SIRᵢⱼ Lᵢⱼ is defined as the “load” of the WTRU mᵢⱼ. The load qᵢ of cell Cᵢ is defined as follows:

$${q}_{1} ≡ {\sum }_{j = 0}^{{N}_{i}} {q}_{ij} . \qquad ( Equation 21 )$$

The interference level Iᵢⱼ can be calculated, for a system where same-cell WTRUs cause negligible interference, as follows:

$${I}_{ij} = θ + {\sum }_{{{i}^{′} = 0}_{{i}^{′} \neq i}}^{N} {\sum }_{{j}^{′} = 0}^{{N}_{{i}^{′}}} \frac{{P}_{{i}^{′} {j}^{′}}}{{L}_{{i}^{′} {j}^{′} ij}} = θ + {\sum }_{{{i}^{′} = 0}_{{i}^{′} \neq i}}^{N} {\sum }_{{j}^{′} = 0}^{{N}_{{i}^{′}}} \frac{{q}_{{i}^{′} {j}^{′}} {I}_{{i}^{′} {j}^{′}}}{{L}_{{i}^{′} {j}^{′} ij}} \qquad ( Equation 22 )$$

where θ is a thermal noise level, and L_{i′j′ij} is a path loss between the WTRU mᵢⱼ and the cell C_{i′}(for DL) or between the WTRU m_{i′j′} and the cell Cᵢ (for UL).

A link gain (inverse of a path loss) between a cell and a WTRU connected to another cell is equal to G_{c}.

$${L}_{{i}^{′} {j}^{′} ij} = \frac{1}{{G}_{c}} if {i}^{′} \neq i . \qquad ( Equation 23 )$$

With this assumption, Equation 22 can be re-written as follows:

$${I}_{ij} = θ + {G}_{c} {{\sum }_{{i}^{′} = 0}^{N}}_{{i}^{′} \neq i} {\sum }_{{j}^{′} = 0}^{{N}_{{i}^{′}}} {q}_{{i}^{′} {j}^{′}} {I}_{{i}^{′} {j}^{′}} . \qquad ( Equation 24 )$$

The right term is independent of j. Therefore, Iᵢ≡Iᵢⱼ ∀j, and Equation 23 can be re-written as follows:

$$\begin{matrix}{I}_{i} = θ + {G}_{c} {{\sum }_{{i}^{′} = 0}^{N}}_{{i}^{′} \neq i} {I}_{{i}^{′}} {\sum }_{{j}^{′} = 0}^{{N}_{{i}^{′}}} {q}_{{i}^{′} {j}^{′}} \\ = θ + {G}_{c} ( {\sum }_{{i}^{′} = 0}^{N} {I}_{{i}^{′}} {q}_{{i}^{′}} - {I}_{i} {q}_{i} ) ∀ i\end{matrix} \qquad ( Equation 25 )$$

From this set of equations (valid for any cell Cᵢ) it is possible to express the interference of any cell, say cell C₀, as a function of the loads qi of all cells and the constant G_{c}. This can be achieved by first considering Equation 24 for i=0 specifically:

$${I}_{0} = θ + {G}_{c} {\sum }_{{i}^{′} = 0}^{N} {I}_{{i}^{′}} {q}_{{i}^{′}} - {G}_{c} {I}_{0} {q}_{0} \qquad ( Equation 26 )$$

Then, combining it with the general equation in i, the following equations are obtained:
Iᵢ=I₀+G_{c}I₀q₀−G_{c}Iᵢqᵢ, or (Equation 27)

$${I}_{i} = {I}_{0} \frac{1 + {G}_{c} {q}_{0}}{1 + {G}_{c} {q}_{i}} ∀ i . \qquad ( Equation 28 )$$

Let C₀ represent the target cell to which codes are being allocated to and Cᵢ represent a neighboring cell. As such, the load q₀ of C₀ will change following the allocation of the codes.

Let q₀ⁱⁿ represent the initial load of C₀, prior to the allocation of codes. Let q₀^{f} represent the final load of C₀, following the allocation of codes. Then,
q₀^{f}=q₀ⁱⁿ+L×SIR (Equation 29)

Equation 28 must be satisfied both prior to and following the allocation of codes to C₀. That is,

$$\begin{matrix}{I}_{i}^{in} = {I}_{0}^{in} \frac{1 + {G}_{c} {q}_{0}^{in}}{1 + {G}_{c} {q}_{i}} ∀ i \\ and & ( Equation 30 ) \\ {I}_{i}^{f} = {I}_{0}^{f} \frac{1 + {G}_{c} {q}_{0}^{f}}{1 + {G}_{c} {q}_{i}} ∀ i & ( Equation 31 )\end{matrix}$$

where I₀ⁱⁿ and I₀^{f} represent respectively the initial and final interference in target cell C₀, and Iᵢⁱⁿ and Iᵢ^{f} represent respectively the initial and final interference in neighbor cell Cᵢ.

The noise rise in neighbor cell Cᵢ is then given by:

$${R}_{N} = \frac{{I}_{i}^{f}}{{I}_{i}^{in}} = \frac{{I}_{0}^{f}}{{I}_{0}^{in}} \times \frac{1 + {G}_{c} {q}_{o}^{f}}{1 + {G}_{c} {q}_{o}^{in}} . \qquad ( Equation 32 )$$

Equation (32) can be rewritten as:

$$\begin{matrix}{R}_{N} = \frac{{I}_{0}^{f}}{{I}_{0}^{in}} \times \frac{1 + {G}_{c} ( {q}_{o}^{in} + L \times SIR )}{1 + {G}_{c} {q}_{o}^{in}} \\ = \frac{{I}_{0}^{f}}{{I}_{0}^{in}} \times ( 1 + \frac{{G}_{C} \times L \times SIR}{1 + {G}_{c} {q}_{o}^{in}} )\end{matrix} \qquad ( Equation 33 )$$

When the initial load of C₀ is unknown, Equation 33 can be simplified to:

$${R}_{N} = \frac{{I}_{0}^{f}}{{I}_{0}^{in}} \times ( 1 + {G}_{C} \times L \times SIR ) \qquad ( Equation 34 )$$

by setting q₀ⁱⁿ to zero. R_{T} corresponds to the noise rise calculated according to Equation 2.

FIG. 4 is a block diagram of an apparatus 400 used to implement CAC in accordance with the present invention. The apparatus 400 communicates with a core network 420 and a WTRU 430, and may reside in an RNC or a Node-B, or any other network entity which is responsible for CAC and radio resource allocation.

The apparatus 400 includes a receiver 402, a code selector 404, a first calculation unit 406, a comparator 408, a second calculation unit 410, and a controller 412. Once a call request is received from the WTRU 430 or the core network 420, the controller 412 initiates a CAC process in accordance with the present invention. The code selector 404 selects a code among available codes in response to the controller 412. The selected code is evaluated for potential allocation to each of available timeslots through calculation of an estimated target cell load and neighbor cell loads based on UL interference, or through calculation of an estimated target cell transmission power and neighbor cell transmission power based on DL interference.

If the CAC process is based on UL interference, the first calculation unit 406 calculates a target cell load and a neighbor cell load for each available timeslot using Node-B measurements and assuming addition of the selected code. The comparator 408 compares the target cell load and the neighbor cell load with predetermined thresholds, respectively. If both the target cell load and the neighbor cell load are below the thresholds, respectively, the code is added to the timeslot for potential allocation. The second calculation unit 410 calculates a weighted system load for the timeslot. The controller 412 controls the overall process and selects a timeslot having a smallest weighted system load among candidate timeslots to allocate for the call request.

If the CAC is based on DL interference, the first calculation unit 406 calculates a target cell transmission power and a neighbor cell transmission power for each available timeslot using Node-B measurements and assuming addition of the selected code. The comparator 408 compares the target cell transmission power and the neighbor cell transmission power with predetermined thresholds, respectively. If both the target cell transmission power and the neighbor cell transmission power are below the thresholds, respectively, the code is added to the timeslot for potential allocation. The second calculation unit 410 calculates a weighted interference for the timeslot. The controller 412 selects a timeslot having a smallest weighted interference among candidate timeslots to allocate for the call request. It is noted that the functions performed by the components with the apparatus 400 may be performed by more or less components as desired.

Although the features and elements of the present invention are described in the preferred embodiments in particular combinations, each feature or element can be used alone without the other features and elements of the preferred embodiments or in various combinations with or without other features and elements of the present invention.

1. In a wireless communication system including at lease one Node-B and at least one wireless transmit/receive unit (WTRU), a method of implementing a call admission control process at a Node-B comprising:
(a) receiving a call request;
(b) selecting a particular code from a code set;
(c) selecting a particular timeslot from a plurality of available timeslots;
(d) calculating a target cell load and a neighbor cell load for the selected timeslot using Node-B measurements and assuming addition of the selected code to the selected timeslot;
(e) calculating a weighted system load for the selected timeslot;
(f) repeating steps (c)-(e) for all other available timeslots;
(g) selecting a timeslot having a smallest weighted system load for allocation of the code; and
(h) removing the code from the code set.

2. The method of claim 1 wherein the weighted system load is calculated only if both the target cell load and the neighbor cell load are below predetermined thresholds, respectively.

3. The method of claim 1 wherein the code is selected starting from a code having a smallest spreading factor.

4. The method of claim 1 wherein the target cell load is calculated using a predicted interference signal code power (ISCP) of the target cell.

5. The method of claim 4 wherein the predicted ISCP in the target cell is calculated using a noise rise function of the target cell.

6. The method of claim 5 wherein the noise rise function of the target cell is calculated using reported path loss measurements.

7. The method of claim 5 wherein the noise rise function of the target cell is calculated using a path loss value parameter determined from a distribution of path losses measured throughout the cell.

8. The method of claim 7 wherein the path loss value parameter is set to 50th percentile path loss of the distribution.

9. The method of claim 1 wherein the neighbor cell load is calculated using a ISCP measured by the neighbor cell.

10. The method of claim 1 wherein the neighbor cell load is estimated with a noise rise function of the target cell.

11. In a wireless communication system including at lease one Node-B and at least one wireless transmit/receive unit (WTRU), a method of implementing a call admission control process at a Node-B comprising:
(a) receiving a call request;
(b) selecting a particular code from a code set;
(c) selecting a particular timeslot from a plurality of available timeslots;
(d) calculating a predicted target cell transmission power and a predicted neighbor cell transmission power for the selected timeslot using Node-B measurements and assuming addition of the selected code to the selected timeslot;
(e) calculating a weighted interference for the timeslot;
(f) repeating steps (c)-(e) for all other available timeslots;
(g) selecting a timeslot having a smallest weighted interference for allocation of the code; and
(h) removing the code from the code set.

12. The method of claim 11 wherein the weighted interference is calculated only if both the predicted target cell transmission power and the predicted neighbor cell transmission power are below predetermined thresholds, respectively.

13. The method of claim 11 wherein the code is selected starting from a code having a smallest spreading factor.

14. The method of claim 11 wherein the predicted target cell transmission power is calculated using a predicted interference signal code power (ISCP) of the target cell.

15. The method of claim 14 wherein the predicted ISCP in the target cell is calculated using a noise rise function of the target cell.

16. The method of claim 15 wherein the noise rise function of the target cell is calculated using reported path loss measurements.

17. The method of claim 15 wherein the noise rise function of the target cell is calculated using a path loss value parameter determined from a distribution of path losses measured throughout the cell.

18. The method of claim 17 wherein the path loss value parameter is set to 50th percentile path loss of the distribution.

19. The method of claim 11 wherein the predicted neighbor cell transmission power is calculated using a transmission power measured by the neighbor cell.

20. The method of claim 11 wherein the predicted neighbor cell transmission power is estimated with a noise rise function of the target cell.

21. An apparatus for admission control based on common measurements of a Node-B in a wireless communication system, a coverage area of the wireless communication system being divided into a plurality of cells and each cell being served by at least one Node-B, the apparatus comprising:
a receiver configured to receive a call request;
a code selector configured to select a code among available codes;
a first calculation unit configured to calculate a target cell load and a neighbor cell load for each available timeslot using Node-B measurements and assuming addition of the selected code,
a second calculation unit for calculating a weighted system load for each of the available timeslots; and
a controller for selecting a timeslot having a smallest weighted system load to allocate for the call request.

22. The apparatus of claim 21 further comprising a comparator for comparing the target cell load and the neighbor cell load of each available timeslot with predetermined thresholds, respectively, whereby the weighted interference is calculated for available timeslots satisfying the thresholds.

23. The apparatus of claim 21 wherein the code is selected starting from a code having a smallest spreading factor.

24. The apparatus of claim 21 wherein the target cell load is calculated using a predicted interference signal code power (ISCP) of the target cell.

25. The apparatus of claim 24 wherein the predicted ISCP in the target cell is calculated using a noise rise function of the target cell.

26. The apparatus of claim 25 wherein the noise rise function of the target cell is calculated using reported path loss measurements.

27. The apparatus of claim 25 wherein the noise rise function of the target cell is calculated using a path loss value parameter determined from a distribution of path losses measured throughout the cell.

28. The apparatus of claim 27 wherein the path loss value parameter is set to 50th percentile path loss of the distribution.

29. The apparatus of claim 21 wherein the neighbor cell load is calculated using a ISCP measured by the neighbor cell.

30. The apparatus of claim 21 wherein the neighbor cell load is estimated with a noise rise function of the target cell.

31. An apparatus for admission control based on common measurements of a Node-B in a wireless communication system, a coverage area of the wireless communication system being divided into a plurality of cells and each cell being served by at least one Node-B, the apparatus comprising:
a receiver configured to receive a call request;
a code selector configured to select a code among available codes;
a first calculation unit for calculating a target cell transmission power and a neighbor cell transmission power for each available timeslot using Node-B measurements and assuming addition of the selected code;
a second calculation unit for calculating a weighted interference for each of the selected timeslots; and
a controller for selecting a timeslot having a smallest weighted interference among timeslots to allocate for the call request.

32. The apparatus of claim 31 further comprising a comparator for comparing the target cell transmission power and the neighbor cell transmission power of each available timeslot with predetermined thresholds, respectively, whereby the weighted interference is calculated for available timeslots satisfying the thresholds.

33. The apparatus of claim 31 wherein the code is selected starting from a code having a smallest spreading factor.

34. The apparatus of claim 31 wherein the predicted target cell transmission power is calculated using a predicted interference signal code power (ISCP) of the target cell.

35. The apparatus of claim 34 wherein the predicted ISCP in the target cell is calculated using a noise rise function of the target cell.

36. The apparatus of claim 35 wherein the noise rise function of the target cell is calculated using reported path loss measurements.

37. The apparatus of claim 36 wherein the noise rise function of the target cell is calculated using a path loss value parameter determined from a distribution of path losses measured throughout the cell.

38. The apparatus of claim 37 wherein the path loss value parameter is set to 50th percentile path loss of the distribution.

39. The apparatus of claim 31 wherein the predicted neighbor cell transmission power is calculated using a transmission power measured by the neighbor cell.

40. The apparatus of claim 31 wherein the predicted neighbor cell transmission power is estimated with a noise rise function of the target cell.
